(19) United States
(12) Patent Application Publication
(10) Pub. No.: US 2009/0080910 A1
(43) Pub. Date: Mar. 26, 2009

(54) METHOD OF DETECTING JAM AND IMAGE FORMING APPARATUS USING THE SAME

(75) Inventors: Dong-sik KIM, Suwon-si (KR); Yun-hye JO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/187,534

(22) Filed: Aug. 7, 2008

(30) Foreign Application Priority Data
Sep. 21, 2007 (KR) 2007-96943

(51) Int. Cl. G03G 13/00

(52) U.S. Cl. 399/21

(57) ABSTRACT

A method of detecting a wrap jam or accordion jam type paper jam and stopping a printing process once a wrap jam or according jam type is detected and an image forming apparatus using the same are provided. The method of detecting the paper jam in the image forming apparatus includes sensing to detect a sheet of paper by using an exit sensor, detecting whether the sheet of paper passes between a transfer roller and an OPC (organic photoconductive) drum for a first time period if the exit sensor does not detect the sheet of paper, and stopping a printing operation of the image forming apparatus if the sheet of paper passes between the transfer roller and the OPC drum for the first time period. Accordingly, it is possible to reduce damage to a fusing roller and increase the lifetime of the fusing roller and other components of the image forming device, if a wrap jam or accordion jam type occurs.

### CROSS-REFERENCE TO RELATED APPLICATIONS

This application claims the benefit and priority under 35 U.S.C. §119(a) of Korean Patent Application No. 10-2007-0096943, filed on Sep. 21, 2007, in the Korean Intellectual Property Office, the disclosure of which is incorporated herein in its entirety by reference.

### BACKGROUND OF THE INVENTION

1. Field of the Invention

The present general inventive concept relates to a method of detecting a jam when forming an image and an image forming apparatus using the same, and more particularly, to a method of detecting a wrap jam or accordion jam and stopping the printing process once a wrap jam or according jam is detected, and an image forming apparatus using the same.

2. Description of the Related Art

FIG. 1 illustrates a structure of a general image forming apparatus.

Referring to FIG. 1, the general image forming apparatus includes a pickup roller 100, a feed roller 110, a feed idle roller 120, a feed sensor 130, an organic photoconductive (OPC) drum 140, a transfer roller 150, a fusing roller 160, a pressure roller 170, an exit sensor 180, an exit roller 190, and an exit idle roller 195.

The pickup roller 100 picks up a sheet of paper from a cassette (not illustrated) that contains sheets of paper. The feed roller 110, together with the feed idle roller 120, draws the picked-up sheet of paper. The feed sensor 130 senses whether the sheet of paper has been normally picked up and supplied by sensing a front end of the sheet of paper. The OPC drum 140 transfers print data, which is developed onto the surface of the OPC drum 140, onto the sheet of paper passing between the OPC drum 140 and the transfer roller 150. The fusing roller 160 fixes the print data onto the sheet of paper by heating the sheet of paper onto which the print data is transferred and, simultaneously together with the pressure roller 170, applies a predetermined pressure on the sheet of paper. The exit sensor 180 determines whether the sheet of paper is normally conveyed to the exit roller 190 by sensing the sheet of paper passing through the fusing roller 160. When the sheet of paper moving in the general image forming apparatus contacts an exit actuator (not illustrated), the exit actuator enables the exit sensor 180 to sense that the sheet of paper is passing through the exit actuator. The exit roller 190, together with the exit idle roller 195, discharges the sheet of paper to the outside of the image forming apparatus.

In case of the aforementioned general image forming apparatus, when a sheet of paper is jammed between the exit sensor 180 and the fusing roller 160, an accordion jam is caused when a heated sheet of paper wrinkles into an accordion-like shape or a wrap jam is caused when a sheet of paper which winds around the fusing roller occurs.

In the general image forming apparatus illustrated in FIG. 1, the exit sensor 180 is located near the fusing roller 160. Accordingly, when toner is excessively transferred to a part near the front end of the sheet of paper, there is a disadvantage in that it is impossible to detect a wrap jam, caused when a sheet of paper winds around the fusing roller 160, or an accordion jam, which is difficult to be removed by a general user, since such jams are determined as having occurred only when the exit sensor 180 senses nothing for a predetermined time period.

Specifically, since the rear end of the sheet of paper is fed into a nip of the exit roller 190 when the front end of the sheet of paper does not enter the nip of the exit roller 190, the accordion jam or wrap jam occurs. Since all the rollers operate for a predetermined time period to allow for the rear part of the sheet of paper to pass through the exit sensor 180, when the accordion jam or wrap jam occurs, most of the sheet of paper completely enters between the exit roller 190 and the fusing roller 160. Accordingly, when the accordion jam or wrap jam occurs, the jam has to be removed by separating the fusing roller 160 from the body of the image forming apparatus, inconveniently.

### SUMMARY OF THE INVENTION

The present general inventive concept provides a method of detecting a wrap or accordion jam and, once the wrap or accordion jam is detected, stopping operations of rollers included in an image forming apparatus, and thereby, reducing damage to a fusing roller, increasing the lifetime of the fusing roller, and preventing deterioration of an exit sensor, and the present general inventive concept also provides an image forming apparatus using the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of detecting a paper jam in an image forming apparatus, and once the paper jam is detected, stopping a printing process therein, the method including sensing to detect a sheet of paper by using an exit sensor, detecting whether the sheet of paper passes between a transfer roller and an OPC (organic photoconductive) drum for a first time period if the exit sensor does not detect the sheet of paper, and stopping a printing operation of the image forming apparatus, if the sheet of paper passes by the transfer roller for the first time period.

In the sensing operation to detect the sheet of paper by using the exit sensor, the sheet of paper may be sensed and detected based on whether a front end of the sheet of paper reaches the exit sensor after a second time period has elapsed from when the front end of the sheet of paper passes by a feed sensor.

In the detecting of whether the sheet of paper passes between the transfer roller and the OPC drum, it may be determined whether the sheet of paper passes through the transfer roller and the OPC drum by sensing a change in a transfer voltage that is applied to the transfer roller.

The first time period may be set by considering a distance between the transfer roller and a rear end of the sheet of paper and a conveying speed of the sheet of paper.

In the detecting of whether the sheet of paper passes between the transfer roller and the OPC drum, it may be detected whether the sheet of paper passes between the transfer roller and the OPC drum by determining whether the transfer voltage is maintained constant for a third time period, which represents that the sheet of paper is not located between the transfer roller and the OPC drum.

The method may include determining that a paper jam occurs in the image forming apparatus if the sheet of paper passes between the transfer roller and the OPC drum for the first time period.

The method may include displaying information regarding an occurrence of the paper jam.

In the displaying of information regarding the occurrence of the paper jam, the information regarding occurrence of the paper jam may be displayed on a display unit of the image forming apparatus or a terminal device connected to the image forming apparatus.

The paper jam may be a wrap or accordion type.

In the stopping of the printing operations of the image forming apparatus, operations of rollers included in the image forming apparatus may be stopped.

The foregoing and/or other aspects and utilities of the present general inventive concept may also be achieved by providing an image forming apparatus including an exit sensor to detect a sheet of paper that has been conveyed between a fusing roller and a pressure roller, and a control unit to detect whether the sheet of paper has passed between a transfer roller and an OPC (organic photoconductive) drum for a first time period in response to a signal representing that the exit sensor has not detected the sheet of paper, and stopping a printing operation of the image forming apparatus if the sheet of paper passes between the transfer roller and the OPC drum for the first time period.

The control unit may determine whether the exit sensor detects the sheet of paper based on whether the sheet of paper reaches the exit sensor after a second time period has elapsed from when a feed sensor detects a front end of the sheet of paper.

The control unit may determine whether the sheet of paper passes between the transfer roller and the OPC drum by sensing a change in a transfer voltage that is applied to the transfer roller.

The control unit may detect whether the sheet of paper passes between the transfer roller and the OPC drum by determining whether a transfer voltage is maintained constant for a third time period which represents that the sheet of paper is not located between the transfer roller and the OPC drum.

The control unit may determine that a paper jam has occurred in the image forming apparatus, if it is determined that the sheet of paper passes between the transfer roller and the OPC drum for the first time period.

The image forming apparatus may include a user interface to display information regarding the paper jam. The paper jam may be a wrap jam or accordion jam type.

The control unit may stop a driving operation of rollers included in the image forming apparatus, if the sheet of paper passes between the transfer roller and the OPC drum for the first time period.

The foregoing and/or other aspects and utilities of the present general inventive concept may also be achieved by providing a method of controlling an image forming apparatus based on whether a wrap or accordion type of paper jam has occurred therein, including sensing to detect whether the accordion or wrap type paper jam has occurred by detecting whether a front end of a sheet of paper to be printed in the image forming apparatus is located in a space between a fusing roller and an exit roller such that the paper is not sensed by an exit sensor disposed between a fusing roller and an exit roller and a predetermined period of time has elapsed since the paper was initially sensed by a feed sensor disposed between a registration roller and a transfer roller, and stopping a printing operation of the image forming apparatus if the accordion or wrap type paper jam is detected.

The predetermined period may be equal to a distance between the feed sensor and the exit sensor divided by a linear speed of the paper in the printing operation.

A transfer voltage applied to the image forming apparatus may transition from a lower level to a higher level after the feed sensor has been actuated and before the exit sensor has been actuated, and the transfer voltage transitions from the higher level to the lower level after the feed sensor becomes de-actuated and before the exit sensor becomes de-actuated.

The foregoing and/or other aspects and utilities of the present general inventive concept may also be achieved by providing a computer-readable recording medium having embodied thereon a computer program to execute a method of detecting a paper jam in an image forming apparatus, the method including sensing to detect a sheet of paper by using an exit sensor, detecting whether the sheet of paper passes between a transfer roller and an OPC (organic photoconductive) drum for a first time period if the exit sensor does not detect the sheet of paper, and stopping printing operations of the image forming apparatus if the sheet of paper is detected as passing by the transfer roller for the first time period.

### BRIEF DESCRIPTION OF THE DRAWINGS

These and/or other aspects and utilities of the present general inventive concept will become apparent and more readily appreciated from the following description of the embodiments, taken in conjunction with the accompanying drawings in which:

FIG. 1 illustrates a structure of a general image forming apparatus;

FIG. 2 illustrates a structure of an image forming apparatus according to an embodiment of the present general inventive concept;

FIG. 3 is a functional block diagram illustrating an image forming apparatus to detect a jam, according to an embodiment of the present general inventive concept;

FIG. 4 is a flowchart of a method of detecting a jam of an image forming apparatus according to an embodiment of the present general inventive concept;

FIG. 5 is a timing diagram of a feed sensor signal, a voltage between an organic photoconductive drum (OPC drum) and a transfer roller, and an exit sensor signal, according to an embodiment of the present general inventive concept; and

FIGS. 6A and 6B are flowcharts illustrating a respective portion of a method of detecting a jam of an image forming apparatus according to an embodiment of the present general inventive concept.

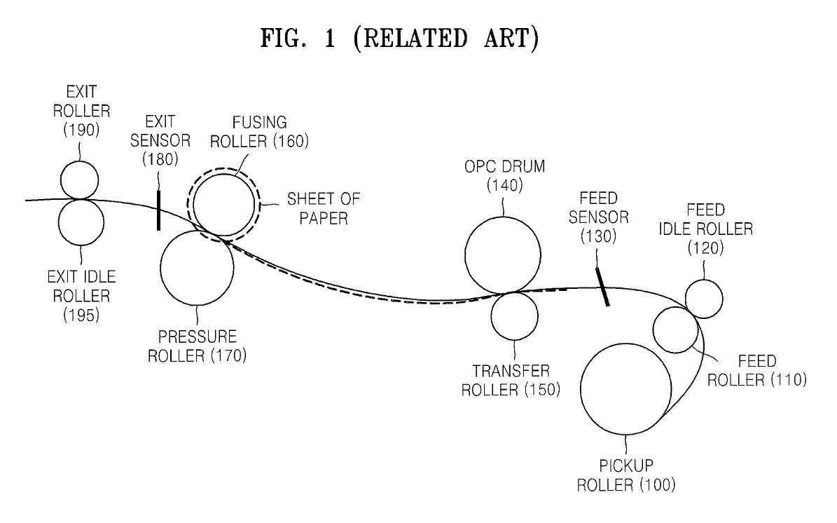

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

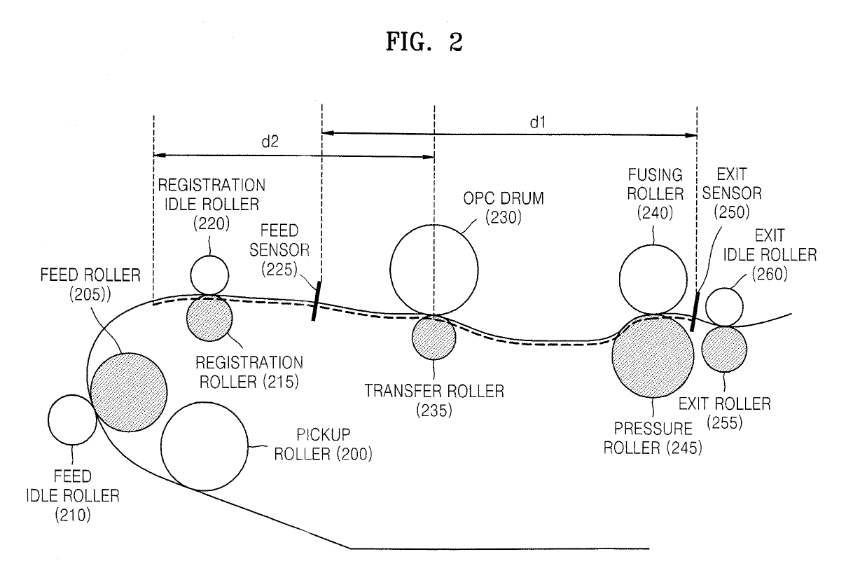

FIG. 2 illustrates a structure of an image forming apparatus, according to an embodiment of the present general inventive concept.

Referring to FIG. 2, the image forming apparatus includes a pickup roller 200, a feed roller 205, a feed idle roller 210, a registration roller 215, a registration idle roller 220, a feed sensor 225, an organic photoconductive drum (OPC) drum 230, a transfer roller 235, a fusing roller 240, a pressure roller 245, an exit sensor 250, an exit roller 255, and an exit idle roller 260.

The pickup roller 200 picks up a sheet of paper from a cassette (not illustrated) containing sheets of paper. The feed roller 205, together with a feed idle roller 210, draws the picked-up sheet of paper. The registration roller 215, together with the registration idle roller 220, aligns a front end of the sheet of paper. The feed sensor 225 senses whether a sheet of paper has been normally picked up and supplied by sensing the front end of the sheet of paper. The OPC drum 230 transfers print data, which is developed onto the surface of the OPC drum 230, onto the sheet of paper passing between the OPC drum 230 and the transfer roller 235. The fusing roller 240 fixes the print data onto the sheet of paper by heating the sheet of paper onto which the print data is transferred and, simultaneously together with the pressure roller 245, applies a predetermined pressure on the sheet of paper. The exit sensor 250 senses whether the sheet of paper is normally conveyed to the exit roller 255 by sensing the sheet of paper passing between the fusing roller 240 and the pressure roller 245. When the sheet of paper, moving in the image forming apparatus, contacts an exit actuator (not illustrated), the exit actuator enables the exit sensor 250 to sense that the sheet of paper passes by the exit actuator (not illustrated). The exit roller 255, together with the exit idle roller 260, discharges the sheet of paper to the outside of the image forming apparatus.

The types of jams that occur in the aforementioned image forming apparatus will be described as follows. For the convenience of description, the jams are classified into a jam 0, a jam 1, and a jam 2 type of jam.

The jam 0 type indicates an error message in a case where the feed sensor 225 does not sense a sheet of paper, once the pickup roller 200 picks up the sheet of paper. That is, if the feed sensor 225 is not actuated once the pickup roller 200 attempts to up the sheet of paper, the sheet of paper cannot be sensed by the feed sensor 225. Thus, if the feed sensor 225 does not sense the sheet of paper once the attempt to pick up the sheet of paper has been accomplished by the pickup roller 200, the pickup roller 200 retries a pickup operation, N (where N is natural number) times. Whenever the pickup roller 200 retries the pickup operation, it is determined whether the feed sensor 225 senses the sheet of paper. If the feed sensor 225 does not sense the sheet of paper for the N times of pickup operations, the jam 0 error message is output to a touchscreen, a display or other user interface device of the image forming apparatus (not illustrated).

The jam 1 type may occur in a case of a feed jam 1 type or an exit jam 1 type. The feed jam 1 type indicates an error message, in the same manner as the jam 0 type error message discussed above, in a case where the feed sensor 225 still senses a sheet of paper after a first sense time has elapsed from when the feed sensor 225 initially sensed the sheet of paper. That is, the feed sensor 225 is still actuated after the first sense time from when the feed sensor 225 was initially actuated. The first sense time is a time period which may be calculated from Equation 1, as follows:

First sense time=((sheet scanning length)÷linear speed)+C1, [Equation 1]

where the sheet scanning length indicates the length of a sheet of paper in a direction of printing print data. For example, if the size of an A4 sheet of paper is 210 mm (width)×297 mm (length) and if the print data is printed in a lengthwise direction of the A4 sheet, the sheet scanning length is 297 mm. The linear speed indicates a conveying speed of a sheet of paper in the image forming apparatus. In this example, C1 indicates a predetermined value.

The exit jam 1 type indicates a case where the exit sensor 250 does not sense the sheet of paper after a second sense time has elapsed from when the feed sensor 225 sensed the sheet of paper. That is, the exit sensor 250 is still de-actuated after the second sense time has elapsed from when the feed sensor 225 was actuated. The second sense time is a time period which may be calculated from Equation 2, as follows:

Second sense time=((distance between the feed sensor 225 and the exit sensor 250)÷linear speed)+C2 [Equation 2]

In this case, a value obtained by dividing the distance between the feed sensor 225 and the exit sensor 250 by the linear speed of the sheet of paper indicates a time that it takes for the front end of the sheet of paper to reach the exit sensor 250 after passing by the feed sensor 225. In this example, C2 indicates a predetermined value.

The jam 2 type indicates an error message in the same manner as the jam 0 type error message discussed above in a case where the exit sensor 250 still senses the sheet of paper after a third sense time has elapsed from when the sheet of paper completely exited the feed sensor 225. That is, the exit sensor 250 remains actuated after the third sense time has elapsed from when the feed sensor 225 was de-actuated. The third sense time is a time period which may be calculated from Equation 3, as follows:

Third sense time=((distance between the feed sensor 225 and the exit sensor 250)÷linear speed)+C3 [Equation 3]

In this case, a value obtained by dividing the distance between the feed sensor 225 and the exit sensor 250 by the linear speed of a sheet of paper indicates a time that it should take for the rear end of the sheet of paper to reach the exit sensor 250 after passing by the feed sensor 225. In this example, C3 indicates a predetermined value.

The exit jam 1 type is a jam type that is desired to be detected by the present general inventive concept, and is more specifically referred to as a wrap jam or an accordion jam type. Hereinafter, a method of detecting the wrap jam or accordion jam type and, once the wrap jam or accordion jam type is detected, stopping the printing process, and an image forming apparatus using the same will be described.

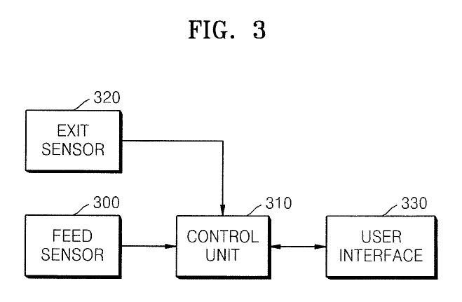

FIG. 3 is a functional block diagram illustrating an image forming apparatus to detect a paper jam, according to an embodiment of the present general inventive concept.

Referring to FIG. 3, the image forming apparatus according to the embodiment includes a feed sensor 300, a control unit 310, an exit sensor 320, and a user interface 330.

The feed sensor 300 senses a sheet of paper conveyed between the registration roller 215 and the registration idle roller 220. A time period that it takes for the front end of the sheet of paper to reach the exit sensor 320 after the feed sensor 300 has sensed the front end of the sheet of paper is calculated by the control unit 310 including the calculation of, the distance d1 (referring to FIG. 2) between the feed sensor 225 and the exit sensor 250÷the linear speed (referring to Equation 2). To calculate a number of checks N1 to be made by the feed sensor 300 to determine whether the front end of the sheet of paper has reached the exit sensor 320, the time period calculated above is multiplied by a check period, which is a time during which the feed sensor 300 performs the N1 checks. The number of checks, N1, of the feed sensor 300 is calculated from Equation 4 as follows:

Number of checks, N1, of the feed sensor 225=((distance between the feed sensor 225 and the exit sensor 250)÷linear speed)×check period of the feed sensor 300, [Equation 4]

where the linear speed indicates a conveying speed of the sheet of paper.

Referring to FIG. 3, the control unit 310 determines whether an actual number of checks of the feed sensor 300 is equal to or greater than the calculated number of checks N1, and determines whether the exit sensor 320 is actuated or de-actuated.

The control unit 310 receives a predetermined signal from the feed sensor 300 and the exit sensor 320, determines a type of a jam based on the received signal of the feed sensor 300 and the exit sensor 320, and transmits the determined type of the jam to the user interface 330 which may be a touch screen, a display or other user interface device of the image forming apparatus (not illustrated). In addition, when the type of the jam as determined by the control unit 310 is a wrap jam or accordion jam, a control signal is output from the control unit 310 to stop operations of the moving rollers included in the image forming apparatus.

Hereinafter, the operation of the control unit 310 will be described in detail.

The control unit 310 receives a signal from the exit sensor 320 after a predetermined time has elapsed from when the feed sensor 300 was actuated. In a case where a signal, representing that the exit sensor 320 is actuated after a predetermined time from when the feed sensor 300 was actuated, is not received, it is determined whether a sheet of paper is located between the OPC drum 230 and the transfer roller 235. If it is determined that the sheet of paper is not located between the OPC drum 230 and the transfer roller 235, the control unit 310 determines the type of the jam and outputs the type of the jam to the user interface 330.

If the feed sensor 300 does not receive a signal representing that the exit sensor 320 is actuated after a predetermined time has elapsed from when the feed sensor 300 was actuated, and the control unit 310 determines that the sheet of paper is located between the OPC drum 230 and the transfer roller 235 for a predetermined period of time or more (referring to FIG. 2), the control unit 310 determines the type of the jam from the obtained result. On the other hand, although the control unit 310 may not receive a signal representing that the exit sensor 320 is actuated after a predetermined time has elapsed from when the feed sensor 300 was actuated, if it is determined that the sheet of paper is located between the OPC drum 230 and the transfer roller 235 only for a predetermined time period of time or less, the control unit 310 determines the type of the jam from the result.

The exit sensor 320 senses a sheet of paper conveyed between the fusing roller 240 and the pressure roller 245. If the distance between the fusing roller 240 and the rear end of the sheet of paper is multiplied by the linear speed when the front end of the sheet of paper reaches the exit sensor 320, it is possible to obtain the time period that it takes for the front end of the sheet of paper to exit from between the fusing roller 240 and the pressure roller 245 after reaching the exit sensor 320. When the time period obtained is multiplied by a check period that is, a time for the paper to be checked by the feed sensor 300 to determine whether the paper has reached the exit sensor 320, the number of sensing operations of the feed sensor 300 is calculated for a time period defined as the time that it takes for the front end of the sheet of paper to exit from between the transfer roller 235 and the OPC drum 230 and to reach the exit sensor 250 (referring to FIG. 2). This is calculated from Equation 5 as follows:

Number of checks N2 of the transfer roller 235 for the time period that it takes for the rear end of the sheet of paper to exit from between the transfer roller 235 and the OPC drum 230 and to reach the exit sensor 250=((distance between the transfer roller 235 and the rear end of the sheet of paper when the exit sensor 320 is actuated)÷linear speed)×check period of the feed sensor 300. [Equation 5]

Referring to FIG. 2, when the front end of the sheet of paper reaches the exit sensor 320, the distance between the transfer roller 235 and the rear end of the sheet of paper is the distance d2.

After a number of checks of the transfer roller 235 is determined by the control unit 310 to be equal to, or greater than, the calculated number of checks N2, the control unit 310 detects whether the sheet of paper is located (that is, jammed) between the transfer roller 235 and the OPC drum 230. The method of detecting whether the sheet of paper is located between the transfer roller 235 and the OPC drum 230 by the control unit 310 will be described as follows.

The OPC drum 230, the sheet of paper, and the transfer roller 235 are modeled as a composite resistance by the control unit 310 in an electrical circuit (not illustrated) by the use of equivalent resistors for the OPC drum 230, the sheet of paper, and the transfer roller 235. A transfer voltage, which is applied to the transfer roller 235, is measured by the control unit 310 based on the composite equivalent resistance of the equivalent resistors substituted for the OPC drum 230, the sheet of paper, and the transfer roller 235. When the transfer voltage, measured by considering the OPC drum 230, the sheet of paper, and the transfer roller 235 as equivalent resistors, is a measured voltage V1, the voltage V1 is different from the transfer voltage measured when the sheet of paper exits between the OPC drum 230 and the transfer roller 235. If the V1 voltage changes from being a constant voltage during a time when the transfer roller 235 is being checked for the number of checks N2, this indicates that the rear end of the sheet of paper has normally passed between the OPC drum 230 and the transfer roller 235 and that the paper is not jammed between the OPC drum 230 and the transfer roller 235.

When a jam occurs, the control unit 310 determines a type of the jam through a method as follows. For example, when the exit sensor 320 is actuated, it is determined by the control unit 310 that the sheet of paper has been normally conveyed to the exit sensor 320. It is possible, however, for a jam to occur after the sheet of paper is conveyed behind the exit sensor 320. Accordingly, when the exit sensor 320 remains actuated for a predetermined time or more, it is determined by the control unit 310 that the type of the jam is the jam 2 type, as described above.

If it is determined by the control unit 310 that the feed sensor 300 is actuated, the exit sensor 320 is de-actuated, and the sheet of paper is not located (that is, not jammed) between the OPC drum 230 and the transfer roller 235, the control unit 310 determines that the jam has occurred after the front end of the sheet of paper has been conveyed between the feed sensor 225 and the transfer roller 235. In this case, it is determined by the control unit 310 that the jam is the exit jam 1 of the jam 1 type, as described above.

In a case where the feed sensor 225 is actuated, the exit sensor 320 is de-actuated, and the sheet of paper is located (that is, jammed) between the OPC drum 230 and the transfer roller 235 for the predetermined time or more, it is determined by the control unit 310 that the jam is the exit jam 1 of the jam 1 type, as described above.

In a case where the feed sensor is actuated, the exit sensor 320 is de-actuated, and the sheet of paper is not located (that is, not jammed) between the OPC drum 230 and the transfer roller 235 after the predetermined time has elapsed, it is determined by the control unit 310 that the jam is a wrap jam or accordion jam type, as described above.

When a jam occurs, the user interface 330 receives from the control unit 310 information regarding the type of the jam that has occurred and displays information regarding the type of the jam to the user via the user interface 330.

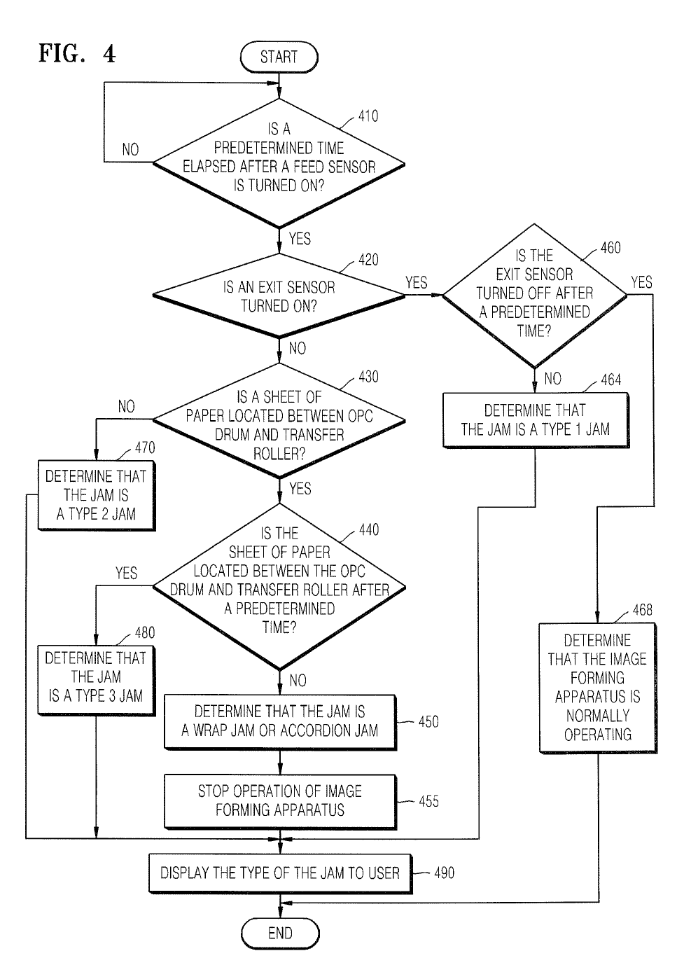

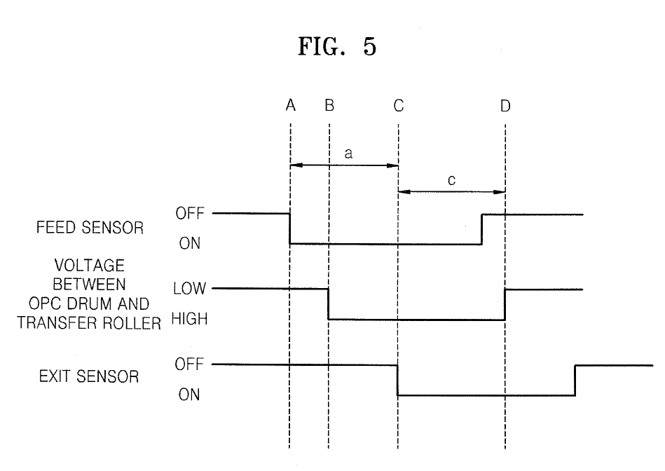

FIG. 4 is a flowchart of a method of detecting a jam of an image forming apparatus according to an embodiment of the present general inventive concept. FIG. 5 is a timing diagram of a feed sensor, a voltage between an OPC drum and a transfer roller, and an exit sensor.

Referring to FIG. 4, a method of detecting a paper jam of the image forming apparatus according to the present embodiment includes a time series of operations in the image forming apparatus shown in FIG. 3. Accordingly, although hereinafter the aforementioned description will be omitted, the aforementioned description on the image forming apparatus shown in FIG. 3 will be also applied to a method of detecting a paper jam in the image forming apparatus according to an embodiment of the present general inventive concept. The method of detecting a paper jam in the image forming apparatus will be described with reference to FIGS. 2, 4, and 5.

In operation 410, the control unit 310 of the image forming apparatus stands by until a second sense time has elapsed once the feed sensor 225 is actuated. The second sense time indicates a time that it takes for the front end of a sheet of paper to reach the exit sensor 250 after passing by the feed sensor 225. The second sense time can be calculated from Equation 2, as described above. Referring to the timing diagram of FIG. 5, the second sense time calculated from Equation 2 is illustrated as a time period between a time A when the feed sensor 225 is actuated, and a time C when the exit sensor 250 is actuated.

More specifically, when the front end of the sheet of paper enables a feed actuator (not shown), the feed sensor 225 is actuated. Since the conveying speed of the sheet of paper in the image forming apparatus is substantially constant regardless of the size of the sheet of paper, the front end of the sheet of paper reaches the exit sensor 250 from the feed sensor 225 in a substantially constant amount of time. Accordingly, if the second sense time calculated from Equation 2 has elapsed after the feed sensor 225 is actuated, it is determined (that is, checked) by the control unit 310 whether the exit sensor 250 is actuated or de-actuated.

In operation 420, the control unit 310 of the image forming apparatus receives a signal from the exit sensor 250 after a predetermined amount of time from when the feed sensor 225 is actuated. If the signal received from the exit sensor 250 is an actuation signal, the present method proceeds to operation 460 since the signal received from the exit sensor 250 indicates that the exit sensor 250 is actuated. If the signal received from the exit sensor 250 is a de-actuation signal, the present method proceeds to operation 430 since the signal received from the exit sensor 250 indicates that the exit sensor 250 is de-actuated.

In operation 430, the control unit 310 of the image forming apparatus determines whether the sheet of paper is located between the OPC drum 230 and the transfer roller 235. A method of measuring a change in a transfer voltage that is applied to the transfer roller 235 based on a modeled composite resistance of the OPC drum 230, the transfer roller 235, and the sheet of paper, as described above, may be used for a method of determining whether the sheet of paper is located between the OPC drum 230 and the transfer roller 235. If the modeled composite resistance of the OPC drum 230 and the transfer roller 235 is different from the actual composite resistance of the OPC drum 230, the transfer roller 235, and the sheet of paper, which occurs when the sheet of paper has passed between the OPC drum 230 and the transfer roller 235, the transfer voltages that are to be applied to the transfer roller 235 and measured by the control unit 310 are different from each other.

Referring to the timing diagram of FIG. 5, it is assumed that the transfer voltage is at a low level when considering the combined resistance of the OPC drum 230 and the transfer roller 235, and it is assumed that the transfer voltage is at a high level when considering the combined resistance of the OPC drum 230, the transfer roller 235, and the sheet of paper. When the transfer voltage, that is, that voltage between the OPC drum 230 and the transfer roller 235, transitions from the low level to the high level (at time B of the timing diagram), this indicates a greater composite resistance value and that the front end of the sheet of paper has passed between the OPC drum 230 and the transfer roller 235. When the transfer voltage transitions from the high level to the low level (at time D of the timing diagram), this indicates a smaller composite resistance value and that the rear end of the sheet of paper has exited between the OPC drum 230 and the transfer roller 235. If it is determined, in operation 430, that the sheet of paper is not located between the OPC drum 230 and the transfer roller 235, the present method proceeds to operation 470. Otherwise, if it is determined that the sheet of paper is located between the OPC drum 230 and the transfer roller 235, the present method proceeds to operation 440.

In operation 440, the control unit 310 of the image forming apparatus determines whether the sheet of paper is located between the OPC drum 230 and the transfer roller 235 after a predetermined time has elapsed. It is possible to distinguish a general exit type 1 jam from a wrap jam or an accordion jam by determining whether the sheet of paper remains disposed between the OPC drum 230 and the transfer roller 235 after a time that it normally takes for the rear end of a sheet of paper to pass between the OPC drum 230 and the transfer roller 235 has elapsed. In this example, the predetermined time is calculated from Equation 5, as described above.

Referring to the timing diagram of FIG. 5, the predetermined time indicates a time period that it takes for the voltage between the OPC drum 230 and the transfer roller 235 to transition to the low level after the exit sensor 250 is actuated, and thus, the predetermined time may be represented by time c. If it is determined, in operation 440, that the sheet of paper is still located between the OPC drum 230 and the transfer roller 235 after the predetermined time has elapsed, the present method proceeds to operation 480. If the sheet of paper is not located between the OPC drum 230 and the transfer roller 235 after the predetermined time has elapsed, the present method proceeds to operation 450.

In operation 450, the control unit 310 of the image forming apparatus determines that the type of the jam is a wrap jam or accordion jam.

In operation 455, the control unit 310 of the image forming apparatus stops operations of the rollers included in the image forming apparatus. The sheet of paper will no longer move due to the stopping of the operations of the rollers in the image forming apparatus.

In operation 460, the control unit 310 of the image forming apparatus determines whether the exit sensor 250 is actuated after a predetermined time has elapsed from when the exit sensor 250 is actuated. If it is determined that the exit sensor 250 is actuated after the predetermined time has elapsed, the present method proceeds to operation 464. Otherwise, if it is determined by the control unit 310 that the exit sensor 250 is de-actuated after the predetermined time has elapsed, the present method proceeds to operation 468.

In operation 464, the control unit 310 of the image forming apparatus determines that the jam is a type 1 jam that indicates a case where the exit sensor 250 is actuated the predetermined time or more.

In operation 468, the control unit 310 of the image forming apparatus determines that the image forming apparatus is operating normally.

In operation 470, the control unit 310 of the image forming apparatus determines that the jam is a type 2 jam that indicates a case where a jam occurs when the front end of the sheet of paper is located between the feed sensor 225 and the transfer roller 235.

In operation 480, the control unit 310 of the image forming apparatus determines that the jam is a type 3 jam that indicates a case where a jam occurs when the front end of the sheet of paper is located between the transfer roller 235 and the exit sensor 250.

In operation 490, the control unit 310 of the image forming apparatus provides information to a user, as described above, regarding the type of the jam that has been determined in operations 450 through 480.

As described above, the types of paper jams that may occur between the feed sensor 225 and the exit sensor 250 are divided into four types. Specifically, in operation 460, a case where a type 1 jam occurs when the front end of the sheet of paper is determined to be located before the exit sensor 250. In operation 470, a case where a type 2 jam occurs when the front end of the sheet of paper is determined to be located between the feed sensor 225 and the transfer roller 235. In operation 480, a case where a wrap jam or accordion jam does not occur although a type 3 jam has occurred since it is determined that the front end of the sheet of paper is located between the transfer roller 235 and the exit sensor 250. A wrap jam or accordion jam in operation 450 occurs when it is determined that the front end of the sheet of paper is located in a space between the fusing roller 240 and the exit roller 255.

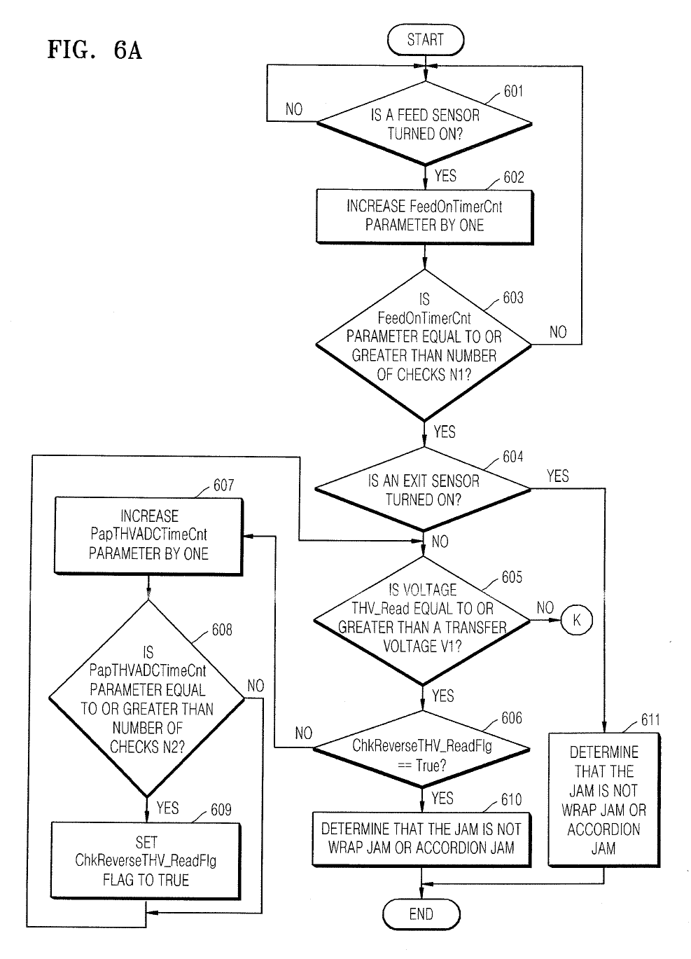

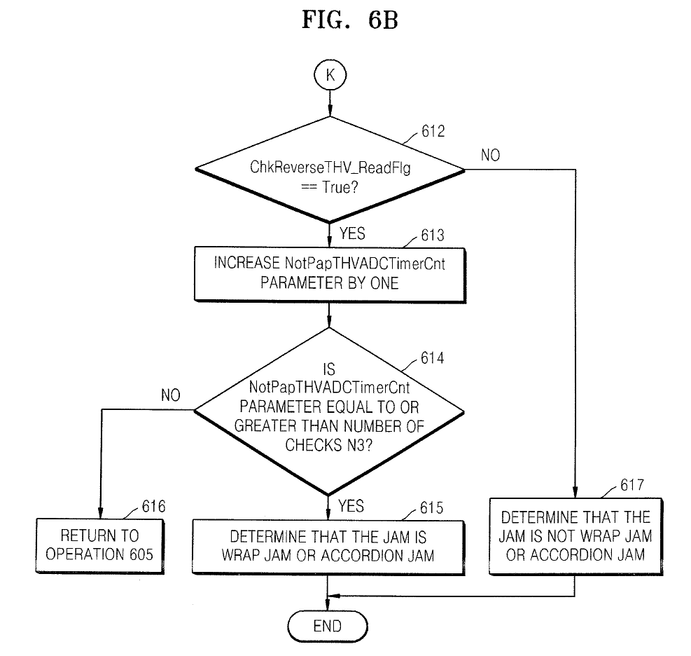

FIGS. 6A and 6B are respective portions of a flowchart illustrating a method of detecting a jam in an image forming apparatus, according to an embodiment of the present general inventive concept, and will be described with reference to FIGS. 2, 6A, and 6B.

Referring to FIG. 6A, in operation 601, the control unit 310 of the image forming apparatus determines whether the feed sensor 225 is actuated. If it is determined that the feed sensor 225 is not actuated, the control unit 310 of the image forming apparatus stands by until the feed sensor 225 is actuated.

In operation 602, once the feed sensor 225, which periodically senses a sheet of paper, is actuated, the control unit 310 of the image forming apparatus increases by one a FeedOnTimerCnt parameter, which is initially set to zero and represents a number of senses of the sheet of paper by using the feed sensor 225.

In operation 603, the control unit 310 of the image forming apparatus determines whether the FeedOnTimerCnt parameter is equal to or greater than a number of checks N1.

In this example, the number of checks N1 indicates the number of checks of the feed sensor 225 for a time period that it normally takes for a front end of a sheet of paper to reach the exit sensor 250 after passing by the feed sensor 225 of the image forming device. When the control unit 310 of the image forming apparatus checks the status of the feed sensor 225 for a predetermined time interval, the number of checks N1 is calculated from Equation 4, as described above. For example, if a distance between the pickup roller 200 and the feed sensor 225 is 120 mm and a distance d1 between the feed sensor 225 and the exit sensor 250 is 170 mm, the number of checks N1 is calculated as (170 [mm]÷93.69 [mm/sec])÷0.01 [sec]=181. That is, the number of checks N1 of the feed sensor 225 by the control unit 310 of the image forming apparatus during a time period that it normally takes for the front end of a sheet of paper to reach the exit sensor 250 after passing by the feed sensor 225, is 181. Accordingly, when the FeedOnTimerCnt parameter is greater than 181, the control unit 310 of the image forming apparatus checks the status of the exit sensor 250.

In operation 604, if it is determined by control unit 310 that the exit sensor 250 of the image forming apparatus is actuated, the present method proceeds to operation 611. Otherwise if it is determined by control unit 310 that the exit sensor 250 is de-actuated, the present method proceeds to operation 605. If the exit sensor 250 is actuated, two cases may be considered. A first case is a case where the sheet of paper is normally conveyed. A second case is a case where a paper jam occurs when the exit sensor 250 is actuated for a predetermined time or more. If the exit sensor 250 is de-actuated, it is possible for a wrap jam or accordion jam to have occurred. The exit sensor 250 is de-actuated at a time when the exit sensor 250 should be actuated, and thus, this indicates that the front end of the sheet of paper has not been conveyed by the exit sensor 250.

In operation 605, the control unit 310 of the image forming apparatus determines whether the transfer voltage THV_Read is equal to or greater than a transfer voltage V1. In this case, since the exit sensor has not yet been actuated, the transfer voltage V1 is not based on the composite resistance obtained by considering the transfer roller 235 and the OPC drum 230, but is instead based on the composite resistance obtained by considering the transfer roller 235, the OPC drum 230, and the sheet of paper.

Hereinafter, a parameter THV_Read is used to represent the transfer voltage. For example, when the THV_Read parameter, corresponding to the composite resistance of the OPC drum 230 and the transfer roller 235, is about 80 V at a normal temperature and humidity, the THV_Read parameter corresponding to the composite resistance of the OPC drum 230, the transfer roller 235, and the sheet of paper ranges from about 100 V to about 110 V at normal temperature and humidity. Accordingly, in this case, the transfer voltage V1 ranges from 80 V to 100 V.

In operation 605, if it is determined by control unit 310 that the transfer voltage THV_Read is less than the transfer voltage V1, the present operation proceeds to a sequence K, illustrated in FIG. 6B. If it is determined by control unit 310 that the transfer voltage THV_Read is equal to or greater than the transfer voltage V1, the present operation proceeds to operation 606.

In operation 606, if a paper jam does not occur, the control unit 310 of the image forming apparatus determines whether a ChkReverseTHV_ReadFlg parameter, which represents whether a time period from when the front end of a sheet of paper reaches the exit sensor 250 to when the rear end of the sheet of paper normally exits from the transfer roller 235 is elapsed, has elapsed. The initial value of the ChkReverseTHV_ReadFFlg parameter is set to indicate that the time period has not elapsed (that is, for example, the parameter is set to false). If the ChkReverseTHV_ReadFlg parameter indicates that the time period has elapsed (that is, for example, the parameter is set to true), this indicates that the time period from when the front end of the sheet of paper reaches the exit sensor 250 to when the rear end of the sheet of paper should have exited from the transfer roller 235 has elapsed. Otherwise, the ChkReverseTHV_ReadFlg parameter indicates that the time period has not elapsed. If it is determined that the ChkReverseTHV_ReadFlg parameter indicates that the time period has elapsed, the current operation proceeds to operation 610. Otherwise, the present operation proceeds to operation 607.

In operation 607, the control unit 310 of the image forming apparatus increases by one a PapTHVADCTimerCnt parameter, which is initially set to zero and represents the number of checks of the transfer voltage after the front end of a sheet of paper reaches the exit sensor 250.

In operation 608, the control unit 310 of the image forming apparatus determines whether the PapTHVADCTimerCnt parameter is equal to or greater than a number of checks N2. In this case, the number of checks N2 is the number of checks of the transfer voltage for a time period from when the front end of a sheet of paper reaches the exit sensor 250 to when the rear end of the sheet of paper should have exited from the transfer roller 235. The time period is calculated by assuming that the sheet of paper has been normally conveyed. In this example, it is assumed that the distance between the pickup roller 200 and the feed sensor 225 is 120 mm, the distance d1 between the feed sensor 225 and the exit sensor 250 is 170 mm, a distance between a contact part (not illustrated) of the transfer roller 235 and the exit sensor 250 is 112 mm, and the sheet of paper is an A4 (210 mm×297 mm) sheet.

In this example, in a case where a paper jam does not occur for a time period from when the front end of the sheet of paper reaches the exit sensor 250 to when the rear end of the sheet of paper exits from the transfer roller 235, the number of checks N2 of the transfer voltage THV_Read for the time period is calculated as, the number of checks N2=(297 mm−112 mm)/93.69 [mm/sec]/0.01 sec=197. In this case, 93.69 [mm/sec] is a linear speed of the sheet of paper, and 0.01 sec is a period of checking the transfer voltage THV_Read by control unit 310. In operation 608, if the PapTHVADCTimerCnt parameter is equal to or greater than number of checks N2, the present operation proceeds to operation 609. Otherwise, if the PapTHVADCTimerCnt parameter is less than the number of checks N2, the present operation returns to operation 605.

In operation 609, the control unit 310 of the image forming apparatus sets the ChkReverseTHV_ReadFlg parameter to be, for example, true, as described above. If the ChkReverseTHV_ReadFlg parameter is set to true, this indicates that the time from when the front end of the sheet of paper reaches the exit sensor 250 to when the rear end of the sheet of paper should have exited from the transfer roller 235 has elapsed.

In operation 610, the control unit 310 of the image forming apparatus determines that the paper jam is not the wrap jam or accordion jam type. If a jam does not occur for a time period from when the front end of the sheet of paper reaches the exit sensor 250 to when the rear end of the sheet of paper should have exited from the transfer roller 235 and the transfer voltage THV_Read is equal to or greater than a transfer voltage V1 after the time period has elapsed, this indicates that the sheet of paper is located (that is, jammed) between the OPC drum 230 and the transfer roller 235. A jam in which the front end of the sheet of paper is located between the transfer roller 235 and the exit sensor 250 may also occur.

In operation 611, the control unit 310 of the image forming apparatus determines that the paper jam is not the wrap jam or accordion jam type. In this case, if the exit sensor 250 is actuated for a predetermined time or more, it is determined by control unit 310 that the jam is a jam 2 type, as described above. Otherwise, it is determined by control unit 310 that the image forming apparatus is normally operating.

Referring to FIG. 6B, in operation 612, the control unit 310 of the image forming apparatus determines whether the ChkReverseTHV_ReadFlg parameter is true, as described above. If it is determined that ChkReverseTHV_ReadFlg parameter is true, this indicates that the exit sensor 250 is de-actuated and the present operation proceeds to operation 613. Otherwise, if it is determined by control unit 310 that the ChkReverseTHV_ReadFlg parameter is false, the present operation proceeds to operation 617.

In operation 613, the image forming apparatus increases by one a NotPapTHVADCTimerCnt parameter, which is initially set to zero and represents a number of checks of the transfer voltage by control unit 310 after the rear end of a sheet of paper exits from the transfer roller 235.

In operation 614, the control unit 310 of the image forming apparatus determines whether the NotPapTHVADCTimerCnt parameter is equal to or greater than a value N3. The value N3 represents the number of checks of the transfer voltage by the control unit 310 after the rear end of a sheet of paper exits from the transfer roller 235, which is a method used to determine whether a paper jam is the wrap jam or accordion jam type. The value N3 is used to create an error range of a normal time period which begins after the rear end of a sheet of paper exits from the transfer roller 235. Since the value N2 in operation 608 increases as a sheet length increases, a major portion of the sheet of paper may be wound around the transfer roller 235 before a wrap jam or accordion jam is determined by control unit 310. To avoid this situation, the value N3 is set to be a small value. If the check period of the transfer roller 235 is, for example, 10 msec, the number of checks N3 of the transfer voltage is 10, and if the wrap jam or accordion jam occurs, it is possible to determine whether the wrap jam or accordion jam occurs after a rear part of a sheet of paper is conveyed from the transfer roller 235 by performing a calculation of, for example, (10 msec×10 times×93.69 [mm/msec])÷9.4 mm. If it is determined, in operation 614, that the NotPapTHVADCTimerCnt parameter is equal to or greater than the value N3, the present operation proceeds to operation 615. Otherwise, if the NotPapTHVADCTimerCnt parameter is less than the value N3, the present operation proceeds to operation 616.

In operation 615, the control unit 310 of the image forming apparatus determines that a paper jam has occurred and is a wrap jam or accordion jam type. If the control unit 310 of the image forming apparatus determines that the jam is the wrap jam or accordion jam type, it is necessary to stop the operation of the image forming apparatus, including the operation of the rollers thereof, to prevent the paper jam from deteriorating the fusing roller 240, or other rollers illustrated in FIG. 2, or other components of the image forming apparatus.

In general, if a paper jam occurs, it is possible to solve the jam problem by the control unit 310 allowing the image forming apparatus to automatically perform a delivery operation of a sheet of paper. However, in a case where a wrap jam or accordion type jam occurs, and when the image forming apparatus automatically performs the delivery operation of the sheet of paper, instead of a manual operation of the user, the jam deteriorates. Accordingly, the operation of the image forming apparatus is stopped until the user solves the wrap jam or accordion jam problem, but, the user can only solve the jam problem once the wrap jam or accordion jam is detected.

In operation 616, the control unit 310 of the image forming apparatus returns to operation 605.

In operation 617, the control unit 310 of the image forming apparatus determines that the jam is not the wrap jam or accordion type jam. Since the method proceeds to operation 617 if the front end of the sheet of paper is located between the feed sensor 225 and the transfer roller 235, the jam is determined by control unit 310 to be of the exit jam 1 type.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Accordingly, it is possible with the present general inventive concept to reduce damage to a fusing roller, increase the lifetime of the fusing roller, and prevent deterioration of an exit sensor, by rapidly determining whether a jam is a wrap jam or accordion jam based on a sensing result of an exit sensor, and stopping operations of rollers included in an image forming apparatus once the wrap jam or accordion jam is detected. In addition, it is possible with the present general inventive concept for a user to easily solve a jam by stopping the operations of the rollers included in the image forming apparatus once the wrap jam or accordion jam is detected, and it is possible to reduce costs of after-sales services caused by the wrap jam or accordion jam.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of detecting a paper jam in an image forming apparatus, and once the paper jam is detected, stopping a printing process therein, the method comprising:
sensing to detect a sheet of paper by using an exit sensor;
detecting whether the sheet of paper passes between a transfer roller and an OPC (organic photoconductive) drum for a first time period if the exit sensor does not detect the sheet of paper; and
stopping a printing operation of the image forming apparatus if the sheet of paper is detected as passing by the transfer roller for the first time period.

2. The method of claim 1, wherein in the sensing to detect the sheet of paper by using the exit sensor, the sheet of paper is sensed and detected based on whether a front end of the sheet of paper reaches the exit sensor after a second time period has elapsed from when the front end of the sheet of paper passes by a feed sensor.

3. The method of claim 1, wherein in the detecting whether the sheet of paper passes between the transfer roller and the OPC drum, it is determined whether the sheet of paper passes through the transfer roller and the OPC drum by sensing a change in a transfer voltage that is applied to the transfer roller.

4. The method of claim 1, wherein the first time period is set by considering a distance between the transfer roller and a rear end of the sheet of paper and a conveying speed of the sheet of paper.

5. The method of claim 1, wherein in the detecting whether the sheet of paper passes between the transfer roller and the OPC drum, it is detected whether the sheet of paper passes between the transfer roller and the OPC drum by determining whether the transfer voltage is maintained constant for a third time period, which represents that the sheet of paper is not located between the transfer roller and the OPC drum.

6. The method of claim 1, further comprising:
determining that a paper jam occurs in the image forming apparatus if the sheet of paper passes between the transfer roller and the OPC drum for the first time period.

7. The method of claim 6, further comprising:
displaying information regarding an occurrence of the paper jam.

8. The method of claim 7, wherein in the displaying of information regarding the occurrence of the paper jam, the information regarding occurrence of the paper jam is displayed on a display unit of the image forming apparatus or a terminal device connected to the image forming apparatus.

9. The method of claim 6, wherein the paper jam is a wrap jam or accordion jam type.

10. The method of claim 1, wherein in the stopping of the printing operations of the image forming apparatus, operations of rollers included in the image forming apparatus are stopped.

11. An image forming apparatus, comprising:
an exit sensor to detect a sheet of paper that has been conveyed between a fusing roller and a pressure roller; and
a control unit to detect whether the sheet of paper has passed between a transfer roller and an OPC (organic photoconductive) drum for a first time period in response to a signal representing that the exit sensor has not detected the sheet of paper, and stopping a printing operation of the image forming apparatus if the sheet of paper passes between the transfer roller and the OPC drum for the first time period.

12. The image forming apparatus of claim 11, wherein the control unit determines whether the exit sensor detects the sheet of paper based on whether the sheet of paper reaches the exit sensor after a second time period has elapsed from when a feed sensor detects a front end of the sheet of paper.

13. The image forming apparatus of claim 11, wherein the control unit determines whether the sheet of paper passes between the transfer roller and the OPC drum by sensing a change in a transfer voltage that is applied to the transfer roller.

14. The image forming apparatus of claim 11, wherein the first time period is set by considering a distance between the transfer roller and a rear end of the sheet of paper and a conveying speed of the sheet of paper.

15. The image forming apparatus of claim 11, wherein the control unit detects whether the sheet of paper passes between the transfer roller and the OPC drum by determining whether a transfer voltage is maintained constant for a third time period which represents that the sheet of paper is not located between the transfer roller and the OPC drum.

16. The image forming apparatus of claim 11, wherein the control unit determines that a paper jam has occurred in the image forming apparatus, if it is determined that the sheet of paper passes between the transfer roller and the OPC drum for the first time period.

17. The image forming apparatus of claim 16, further comprising:
a user interface to display information regarding the paper jam.

18. The image forming apparatus of claim 16, wherein the paper jam is a wrap jam or accordion jam type.

19. The image forming apparatus of claim 11, wherein the control unit stops a driving operation of rollers included in the image forming apparatus, if the sheet of paper passes between the transfer roller and the OPC drum for the first time period.

20. A method of controlling an image forming apparatus based on whether a wrap or accordion type of paper jam has occurred therein, comprising:
sensing to detect whether the accordion or wrap type paper jam has occurred by detecting whether a front end of a sheet of paper to be printed in the image forming apparatus is located in a space between a fusing roller and an exit roller such that the paper is not sensed by an exit sensor disposed between a fusing roller and an exit roller and a predetermined period of time has elapsed since the paper was initially sensed by a feed sensor disposed between a registration roller and a transfer roller; and
stopping a printing operation of the image forming apparatus if the accordion or wrap type paper jam is detected.

21. The method of claim 20, wherein the predetermined period is equal to a distance between the feed sensor and the exit sensor divided by a linear speed of the paper in the printing operation.

22. The method of claim 20, wherein a transfer voltage applied to the image forming apparatus transitions from a lower level to a higher level after the feed sensor has been actuated and before the exit sensor has been actuated, and the transfer voltage transitions from the higher level to the lower level after the feed sensor becomes de-actuated and before the exit sensor becomes de-actuated.

23. A computer-readable recording medium having embodied thereon a computer program to execute a method of detecting a paper jam in an image forming apparatus, the method comprising:
sensing to detect a sheet of paper by using an exit sensor;
detecting whether the sheet of paper passes between a transfer roller and an OPC (organic photoconductive) drum for a first time period if the exit sensor does not detect the sheet of paper; and
stopping printing operations of the image forming apparatus if the sheet of paper is detected as passing by the transfer roller for the first time period.
